(19) United States
(12) Patent Application Publication
(10) Pub. No.: US 2026/0196092 A1
(43) Pub. Date: Jul. 9, 2026

(54) PRODUCT STORAGE

(71) Applicant: WEVERSE COMPANY INC., Seongnam-si (KR)

(72) Inventor: Seong Hyun KIM, Seongnam-si (KR)

(21) Appl. No.: 19/559,144

(22) Filed: Mar. 6, 2026

Related U.S. Application Data
(63) Continuation of application No. PCT/KR2024/013302, filed on Sep. 4, 2024.

(30) Foreign Application Priority Data
Sep. 8, 2023 (KR) 10-2023-0119800
May 9, 2024 (KR) 10-2024-0061316

(51) Int. Cl. G07F 9/00; G07F 9/02; G07F 17/10

(52) U.S. Cl. CPC G07F 9/006; G07F 9/002; G07F 9/026; G07F 17/10

(57) ABSTRACT

Disclosed is a product storage for storing at least one product therein and managing insertion and removal of the stored product, the product storage comprising: a main frame having an accommodation space defined therein; a camera configured to capture the accommodation space defined within the main frame; a weight sensor configured to measure a weight of at least one product stored in the accommodation space defined within the main frame; and a communication module configured to transmit and receive, to and from a central server, data received from the camera and the weight sensor.

### CROSS-REFERENCE TO RELATED APPLICATIONS

This application is a Continuation of Application No. PCT/KR2024/013302, filed on Apr. 9, 2024, which in turn claims the benefit of Korean Patent Applications No. 10-2023-0119800, filed on Aug. 9, 2023, and No. 10-2024-0061316, filed on Sep. 5, 2024. The entire disclosures of all these applications are hereby incorporated by reference.

### TECHNICAL FIELD

The present disclosure relates to a product storage. More particularly, the present disclosure relates to a product storage device for storing predetermined products to be provided to customers under a pickup system in which customers pick up the predetermined products at a reception booth.

### BACKGROUND ART

As living standards improves, interest in various events, such as performances, exhibitions, concerts, and other events, is increasing.

At such event venues, especially concert venues, products (merchandise) related to entertainers appearing in the concerts are sold, and a large number of customers (buyers) want to purchase such entertainer-related products due to the large crowds.

However, at product purchase sites, when a customer wishes to purchase multiple products, the customer must memorize the desired products or write them down in a notepad and present the information to an operator or staff member. The operator then must move repeatedly in response to the customer's instructions or go and retrieve the products ordered by the customer one by one while recalling the order details. During this process, memory errors often result in incorrect picking of product types or quantities, thereby causing significant inefficiency.

In addition, because purchases are usually made at crowded sites, pedestrian traffic flow among customers and operators often becomes disrupted, frequently leading to confusion.

To solve this problem, a pickup system has been developed in which products are purchased online first and only pickup is performed at on site. However, even in this case, operators must memorize where each product is loaded, as the number of operators increases, picking sequences may overlap, causing congestion in movement paths. Further, there is no procedure to verify whether the quantities picked by the operators are correct, resulting in economic losses due to operator errors.

In addition, when a product that an operator intends to pick is not in the designated picking space, the operator has to go to a separate warehouse and replenish the product in the space, causing additional time loss.

In addition, even when a customer receives fewer or more products than ordered due to an operator's negligence, there is no data to prove what was received, so that a customer may maliciously receive duplicate products.

In order to solve the above-described problems, there is a need to develop a technology that enables operators to efficiently provide products requested for pickup to customers.

### DISCLOSURE

### Technical Problem

The present disclosure is intended to provide a product storage having a structure for managing storage statuses and insertion and removing pickup target products loaded therein.

Further, the present disclosure is intended to provide a product storage including a device for assisting an operator in accurate picking.

Further, the present disclosure is intended to provide a method for providing a pickup service using a product storage that generates an order form according to the types and quantities of products ordered by a customer.

Further, the present disclosure is intended to provide a method for providing a pickup service using a product storage that calculates an optimal picking route based on the storage locations of respective products.

Further, the present disclosure is intended to provide a method for providing a pickup service using a product storage that updates a picking list based on picking sequences of other operators.

Further, the present disclosure is intended to provide a method for providing a pickup service using a product storage that generates data for certifying the competition of a pickup, while including an electronic signature of a customer.

However, the technical purposes to be achieved by the present disclosure and the embodiments of the present disclosure are not limited to the technical purposes described above, and other technical purposes may exist.

### Technical Solution

A product storage for storing at least one product therein and managing insertion and removal of the stored product according to an embodiment of the present disclosure comprises: a main frame having an accommodation space defined therein; a camera configured to capture the accommodation space defined within the main frame; a weight sensor configured to measure a weight of at least one product stored in the accommodation space defined within the main frame; and a communication module configured to transmit and receive, to and from a central server, data received from the camera and the weight sensor.

In addition, the camera may be disposed at a center of an inner surface of an upper end of the main frame.

In addition, the weight sensor may be disposed at a location having a predetermined clearance from a bottom surface of a lower end of the main frame.

In addition, the product storage may further comprise the central server configured to transmit and receive, to and from the communication module, the data received from the camera and the weight sensor, and the central server may be configured to control the product storage by analyzing insertion and removal of the product in the product storage based on the data received from the camera and the weight sensor.

In addition, when the product storage includes a plurality of product storages, the central server may be configured to match location information to a unique identification number for each product storage.

In addition, the main frame may have a front surface and a rear surface, at least one of which is configured to open so that the accommodation space within the main frame communicates with the outside, and the main frame may further include a cover disposed on the at least one openable surface and pivotable between an open position and a closed position.

In addition, the main frame may further include: a first label indicator disposed on a front surface of the main frame; and a second label indicator disposed on a rear surface of the main frame.

In addition, the first label indicator may be a display module configured to display first display information, including at least one of location information, pickup worker information, a pickup quantity, and a product identification code.

In addition, the second label indicator may be a display module configured to display second display information, including at least one of location information, availability information, and a product identification code.

In addition, the second label indicator may include an LED module configured to emit light based on the availability information.

In addition, the main frame may be formed in a box shape such that, when the product storage includes a plurality of product storages arranged adjacent to each other, at least one of an upper end, a lower end, a left side surface, and a right side surface thereof is in contact with another product storage.

In addition, the communication module may be configured to transmit, to the central server, a first captured image received from the camera and obtained by capturing the at least one product stored within the main frame and insertion and removal of the at least one product.

In addition, the communication module may be configured to transmit, to the central server, a first weight received from the weight sensor and obtained based on the at least one product stored within the main frame.

In addition, the central server may be configured to: determine, when the product storage includes a plurality of product storages, whether products are present within a first product storage based on at least one of a first captured image and a first weight obtained for the first product storage; and determine availability information as either an available state or an unavailable state based on the determined presence or absence of the products.

In addition, the central server may be configured to: control the LED module to emit blue light when the availability information indicates an available state; and control the LED module to emit red light when the availability information indicates an unavailable state.

In addition, the central server may be configured to calculate a quantity of products within the first product storage based on the first captured image and the first weight.

### Advantageous Effects

The product storage according to an embodiment of the present disclosure has a structure for managing storage statuses and insertion and removal of the pickup target products loaded therein, thereby enabling identification of a time point at which loading is required, and allowing personnel separate from personnel performing picking to perform loading to greatly increase the efficiency of picking work.

In addition, the product storage according to an embodiment of the present disclosure includes a device for assisting a normal picking of the operator, thereby greatly reducing the probability of occurrence of mis-picking to prevent time/economic losses due to mis-picking.

In addition, the method for providing the pickup service using the product storage according to an embodiment of the present disclosure generates an order form according to types and quantities of products ordered by a customer, thereby reducing face-to-face time between the customer and an operator to increase procedural convenience, and improving convenience for the operator in performing picking work based on the order form.

In addition, the method for providing the pickup service using the product storage according to an embodiment of the present disclosure calculates an optimal picking route based on storage locations of respective products, thereby increasing promptness in service provision, enabling fast work processing, and thus increasing customer satisfaction.

In addition, the method for providing the pickup service using the product storage, according to an embodiment of the present disclosure, updates a picking list based on the picking sequences of other operators, thereby preventing overlap of picking routes between operators, reducing confusion, and thereby reducing the total time required to perform picking work.

In addition, the method for providing the pickup service using the product storage according to an embodiment of the present disclosure generates data for certifying a normal pickup while including an electronic signature of a customer, thereby preventing duplication and omission in pickup of the customer to prevent economic loss, securing objective data for proving mis-picking, and thus improving reliability between the customer and a service provider.

However, effects obtainable in the present disclosure are not limited to the effects mentioned above, and other effects not mentioned may be clearly understood from the following description.

### DESCRIPTION OF DRAWINGS

FIG. 1 is a conceptual diagram of a pickup service providing system according to an embodiment of the present disclosure.

FIG. 2 is an internal block diagram of a product storage according to an embodiment of the present disclosure.

FIGS. 3 to 5 are examples illustrating the shape of a product storage according to an embodiment of the present disclosure.

FIG. 6 is an example of a product storage module composed of a plurality of product storage units according to an embodiment of the present disclosure.

FIG. 7 shows operators and purchasers using a pickup booth in which a product storage module is disposed, according to an embodiment of the present disclosure.

FIG. 8 is an internal block diagram of a terminal according to an embodiment of the present disclosure.

FIG. 9 is a flowchart for illustrating a method for performing a pickup process according to an embodiment of the present disclosure.

FIG. 10 is an example of a receipt confirmation according to an embodiment of the present disclosure.

FIG. 11 is a flowchart for illustrating a method for performing a picking process according to an embodiment of the present disclosure.

FIG. 12 shows an example picking list according to an embodiment of the present disclosure.

FIGS. 13 and 14 illustrate examples of an operator performing a picking process based on a picking list displayed on an operator terminal according to an embodiment of the present disclosure.

FIG. 15 is an example of a user interface for an operator for inputting an electronic signature according to an embodiment of the present disclosure.

### BEST MODE FOR INVENTION

Because the present disclosure may be applied with various modifications and may have various embodiments, specific embodiments will be illustrated in the drawings and described in detail in the detailed description. The effects and features of the present disclosure and methods for achieving them will be apparent with reference to the embodiments described in detail below, together with the drawings. However, the present disclosure may not be limited to the embodiments disclosed below, but may be implemented in various forms. In the following embodiments, terms such as “first”, “second”, and the like are used for the purpose of distinguishing one component from another, rather than having limited meanings. In addition, singular expressions include plural expressions unless the context clearly indicates otherwise. In addition, terms such as “include” or “have” indicate the presence of features or components described herein, and do not preclude the possibility that one or more other features or components may be added. In addition, the drawings may show the components'sizes exaggerated or reduced for convenience of description. For example, the size and thickness of each component illustrated in the drawings are arbitrarily determined for convenience of description, and thus, the present disclosure is not necessarily limited to those.

Hereinafter, embodiments of the present disclosure will be described in detail with reference to the accompanying drawings, the same or corresponding components will be given the same reference numerals when described with reference to the drawings, and redundant descriptions thereof will be omitted.

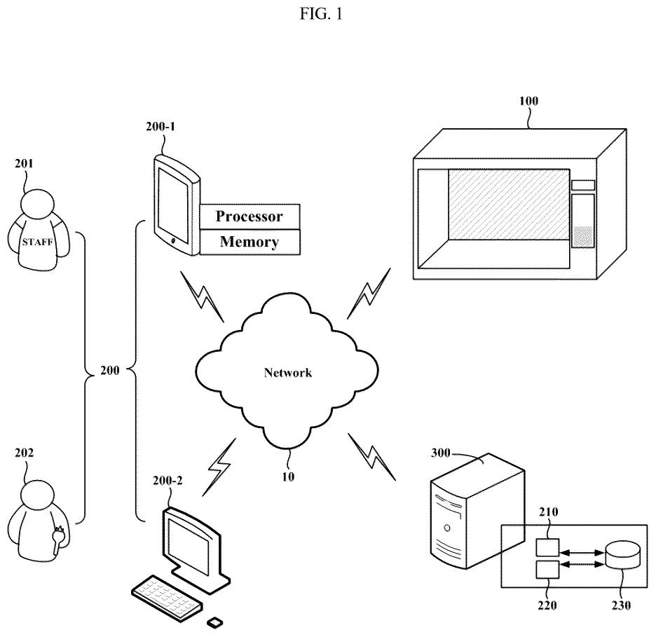

FIG. 1 is a conceptual diagram of a pickup service providing system according to an embodiment of the present disclosure.

Referring to FIG. 1, a pickup service providing system (hereinafter, referred to as a service providing system) according to an embodiment of the present disclosure may provide a pickup service (hereinafter, referred to as a pickup service) in which, when a purchaser places an order for products, the ordered products are picked and provided to the purchaser along an optimal picking route based on a product storage having a structure for managing storage statuses and insertion and removal of pickup target products.

Pickup, according to an embodiment of the present disclosure, refers to an overall act of a purchaser ordering products online, visiting an offline site, and receiving the ordered products from an operator.

In addition, picking refers to an act of taking products to be sent from a storage location of a logistics warehouse, and in an embodiment of the present disclosure, may refer to an act in which an operator takes out products ordered by a purchaser from the product storage.

That is, the pickup service, according to an embodiment, is provided based on a pickup process in the sequence of ‘order of a purchaser, on-site visit of the purchaser, picking of products by an operator at the visited site, receipt of the picked products by the purchaser, and completion of pickup upon receipt’. In other words, the pickup process may include a picking process in which an operator picks products.

Hereinafter, for convenience of description, it will be described that the picking process is performed at an operator terminal 201, and the pickup process is performed at a purchaser terminal 202.

Further, in an embodiment of the present disclosure, the purchaser may refer to a customer who orders products online and receives the products from an operator at an offline site.

In an embodiment, the service providing system implementing the pickup service as described above may be connected through a product storage 100, a terminal 200, a central server 300, and a network 10.

In this regard, the network 10, according to an embodiment, refers to a connection structure in which information may be exchanged between respective nodes, such as the product storage 100, the terminal 200, and/or the central server 300. Examples of the network 10 include a 3rd Generation Partnership Project (3GPP) network, a Long Term Evolution (LTE) network, a Worldwide Interoperability for Microwave Access (WIMAX) network, the Internet, a local area network (LAN), a wireless local area network (Wireless LAN), a wide area network (WAN), a personal area network (PAN), a Bluetooth network, a satellite broadcast network, an analog broadcast network, a digital multimedia broadcasting (DMB) network, and the like, but are not limited thereto.

Hereinafter, the product storage 100, the terminal 200, and/or the central server 300 implementing the service providing system will be described in detail with reference to the accompanying drawings.

### Product Storage 100

The product storage 100, according to an embodiment of the present disclosure, may be a predetermined computing device that assists the pickup service.

In an embodiment of the present disclosure, the predetermined computing device assisting the pickup service will be described based on being implemented as the product storage 100, but may be implemented through a mobile computing device and/or a desktop computing device and a peripheral device associated therewith.

In addition, according to an embodiment, the product storage 100 may further include a predetermined server computing device that provides a pickup service environment.

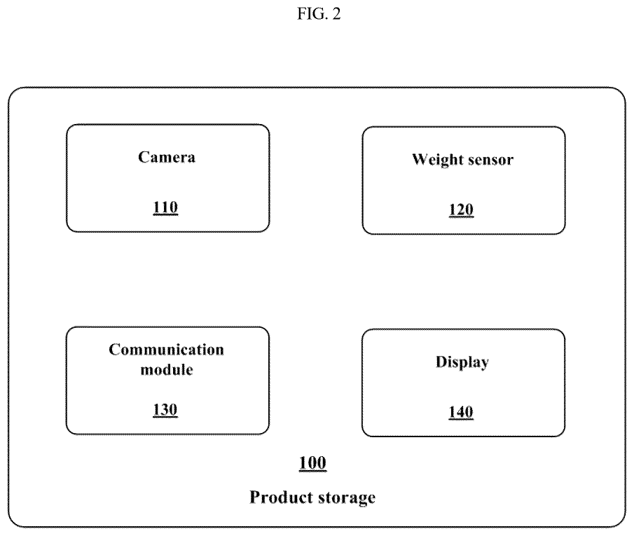

FIG. 2 is an internal block diagram of a product storage according to an embodiment of the present disclosure.

Referring to FIG. 2, from a functional point of view, the product storage 100 may include a camera 110, a weight sensor 120, a communication module 130, and/or a display 140.

The camera 110 may capture an image and/or a video of a physical space around the product storage 100.

In addition, the camera 110 may capture and obtain various images and/or videos related to the pickup service.

In detail, the camera 110 may capture an inner space of the product storage 100. In more detail, the camera 110 may capture at least one product stored inside the product storage 100 and the movement of the products into and out of the product storage.

Such a camera 110 may obtain an image in a direction to capture the inner space of the product storage 100. That is, the camera 110 may capture a physical space through a camera disposed to face the inner space of the product storage 100.

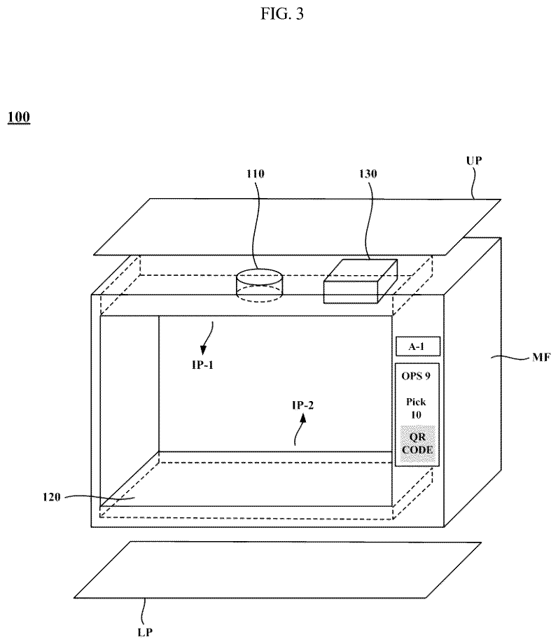

FIG. 3 is an example illustrating an internal structure of a product storage according to an embodiment of the present disclosure.

Referring to FIG. 3, the camera 110 may be disposed at the center of a first inner surface IP-1 of an upper end UP of a main frame MF to capture the inside of the main frame MF.

In this regard, the camera 110 may be disposed at the center of the first inner surface IP-1 of the upper end UP so that the entire interior of the main frame MF is included in a field of view.

Such a camera 110 may include an image sensor device and an image processing module. Specifically, the camera 110 may process a still image or a moving image obtained by the image sensor device (e.g., a CMOS or a CCD).

In addition, the camera 110 may extract necessary information by processing the still image or the moving image obtained through the image sensor device using an image recognition process (e.g., OCR, etc.) and/or the image processing module, and transmit the extracted information to the communication module 130.

Such a camera 110 may be a camera assembly including at least one camera. The camera assembly may include a general camera for capturing an image in a visible light band, and may further include a special-purpose camera such as an infrared camera, a stereo camera, or the like.

In addition, the camera 110 as described above may operate while being included in the product storage 100 according to an embodiment, or may operate in association with the above-described communication module 130 while being included in an external device (e.g., an external server, etc.).

In an embodiment, such a camera 110 may capture an image indicating whether there is a product inside the product storage 100 and whether there is a movement sensed inside the product storage 100.

The weight sensor 120 may sense and measure the weight of a product included in the product storage 100.

Specifically, the weight sensor 120 may measure a weight variation value according to the presence or absence of the product included in the product storage 100.

To this end, the weight sensor 120 may include a strain gauge that converts a physical force generated by the weight of the product included in the product storage 100 into an electrical signal.

Referring back to FIG. 3, the weight sensor 120 may be disposed on a second inner surface IP-2 of a lower end LP (or a bottom surface of the lower end LP) of the main frame MF to measure the weight of the product included within the main frame MF.

Such a weight sensor 120 may be disposed to have a predetermined clearance from the second inner surface IP-2 of the lower end LP of the main frame MF.

This may be to prevent pressure from being applied by the weight of another product storage 100 located above even when a plurality of product storage 100 are stacked on one another.

The communication module 130 may include one or more devices for being in communication with an external terminal and/or server (in an embodiment, a plurality of operator terminals 201 and/or a central server 300). Such a communication module 130 may perform communication over a wireless network.

Specifically, the communication module 130 may be in communication with the terminal 200 storing a content source for implementing a pickup service environment, and may be in communication with various user input components, such as a controller that receives a user input.

In an embodiment, the communication module 130 may transmit and receive various data related to the pickup service to and from other terminals 200 and/or the external server.

In addition, the communication module 130 may wirelessly transmit and receive data to and from at least one of a base station, an external terminal, and an arbitrary server on a mobile communication network built through a communication device capable of supporting technical standards for mobile communication or communication schemes (e.g., long term evolution (LTE), long term evolution-advanced (LTE-A), 5G new radio (5G NR), and WIFI), or short-range communication schemes.

Such a communication module 130 may include a router for wireless communication.

In addition, in an embodiment, the communication module 130 may include a processor that analyzes variation values of the camera 110 and/or the weight sensor 120.

Accordingly, in an embodiment, the communication module 130 may control the product storage 100 by transmitting and receiving the information received from the camera 110 and/or the weight sensor 120 described above and analyzed, to and from the central server 300 through the network 10 in real time.

That is, the central server 300, which obtains a first captured image captured by the camera 110 and a first weight measured by the weight sensor 120 from the communication module 130, may determine whether a product is present in a first product storage. Details thereof will be described later in the description of the central server.

Such a communication module 130 may be embedded in the main frame MF, and FIG. 3 exemplarily illustrates a state in which the communication module 130 is disposed inward of the upper surface UP of the main frame MF.

The display 140 may output various information related to the pickup service in a graphical form.

For example, the graphics may include colors, texts, images, and/or videos.

Such a display 140 may include a display that outputs graphics.

The display may include at least one of a liquid crystal display (LCD), a thin film transistor-liquid crystal display (TFT LCD), an organic light-emitting diode (OLED), a flexible display, a three-dimensional display (3D display), an e-ink display, and an electronic shelf label (ESL).

In addition, in an embodiment, the display 140 may include a first label indicator, a second label indicator, and/or an LED module.

In this regard, in an embodiment, the first label indicator and/or the second label indicator may be implemented as ESLs that display predetermined text and/or images (e.g., QR code images).

In an embodiment, such a display 140 may be in communication with the central server 300 using wireless technology to display information necessary for the pickup service in real time.

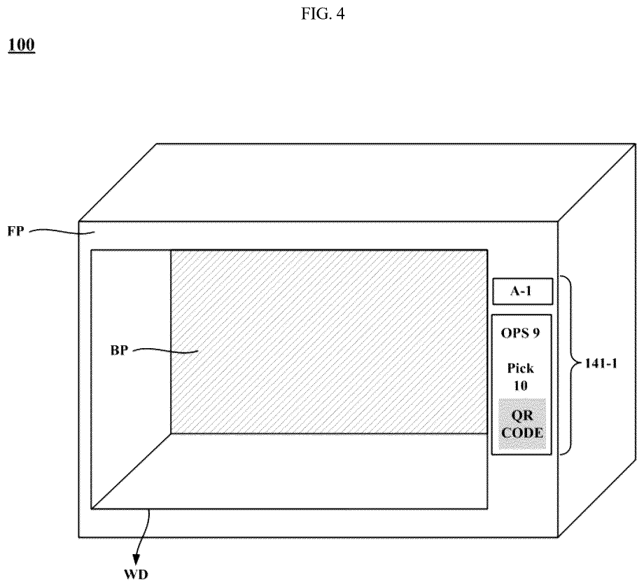

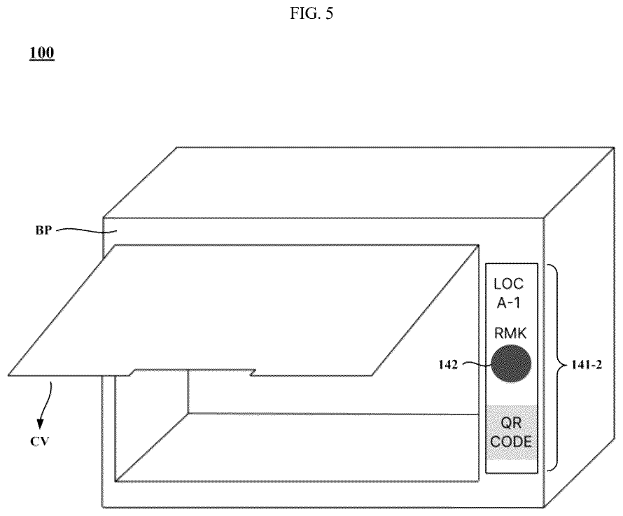

The product storage 100, including the plurality of components described above, may be implemented in a rectangular box structure in which an accommodation space is defined as illustrated in FIGS. 4 and 5 in terms of hardware.

FIG. 4 is an example illustrating a front surface of a product storage according to an embodiment of the present disclosure, and FIG. 5 is an example illustrating a rear surface of a product storage according to an embodiment of the present disclosure.

In an embodiment, the product storage 100 may have the main frame MF as a basic structure in which at least one of a front surface FP and/or a rear surface BP is opened so that the internal accommodation space is in communication with the outside.

Referring to FIG. 4, in an embodiment, the product storage 100 may include a window WD and/or a first label indicator 141-1 on the front surface FP.

In an embodiment, the window WD may have an area size smaller than or equal to the area size of the front surface FP of the main frame MF.

In addition, in an embodiment, the window WD may be made of a transparent material such as an acrylic material.

Accordingly, a user who uses the product storage 100 may identify which product is stored in the product storage 100 through the window WD.

In addition, in an embodiment, the window WD may be implemented in a pivotable structure that is opened and closed under the control of a user.

In an embodiment, the first label indicator 141-1 may be disposed at one side of the front surface FP of the main frame MF.

In addition, in an embodiment, the first label indicator 141-1 may display first display information including at least one of location information, pickup worker information, a pickup quantity, and/or a product identification code (e.g., a QR code).

In this regard, the location information, the pickup worker information, and/or the pickup quantity may be displayed as text, and the product identification code may be displayed as an image.

For example, the location information may be displayed as a location number such as “A-1”. In addition, the pickup worker information may be displayed as “OPS 9”, assuming that a pickup worker is worker No. 9. In addition, when it is assumed that the pickup quantity is ten, the pickup quantity may be displayed as “Pick 10”. In addition, the product identification code may be displayed as a QR code.

Hereinafter, for convenience of description, the product identification code will be described based on being implemented as the QR code.

Referring to FIG. 5, in an embodiment, the product storage 100 may include a cover CV, a second label indicator 141-2, and/or an LED module 142 on the rear surface BP.

In an embodiment, the cover CV may be disposed at a location facing the window WD disposed in the front surface FP of the product storage 100.

In addition, in an embodiment, the cover CV may have an area size smaller than or equal to the area size of the rear surface BP of the main frame MF.

In addition, in an embodiment, the cover CV may be implemented in a pivotable structure that is opened and closed under the control of a user.

In this regard, a pivoting scheme of the cover CV may be a hinge scheme, a sliding scheme, and/or a push scheme. However, because loading and unloading of the product into and from the product storage 100 may be hindered depending on the pivoting scheme of the cover CV, the following description will be made based on the hinge scheme in which the cover CV is opened outward, but the present disclosure is not limited thereto.

Accordingly, a user using the product storage 100 may insert or remove a product into or from the product storage 100 when the cover CV is opened, and the product stored in the product storage 100 may be safely stored when the cover CV is closed.

In an embodiment, the second label indicator 141-2 may be disposed at one side of the rear surface BP of the main frame MF.

In addition, in an embodiment, the second label indicator 141-2 may display second display information including at least one of location information, availability information, and/or a product identification code (e.g., a QR code).

In this regard, the location information displayed on the first label indicator and the second label indicator may be the same. For example, when the location information matches the first product storage, A-1, ‘A-1’may be displayed on both the first label indicator and the second label indicator.

In addition, for example, the availability information may be indicated using the LED module 142 together with the text “RMK”. When the availability information indicates an available state, the LED module 142 may emit blue light. On the other hand, when the availability information indicates an unavailable state, the LED module 142 may emit red light.

In addition, the product identification codes (e.g., the QR codes) displayed on the first label indicator and the second label indicator may be the same. Because the identification code corresponds to a product stored in the first product storage, the same identification code may be matched as the same product is stored therein.

In addition, in an embodiment, the second label indicator 141-2 may include the LED module 142 that emits light based on the availability information.

In this regard, the LED module 142 may emit blue light when the availability information indicates the available state.

On the other hand, the LED module 142 may emit red light when the availability information indicates the unavailable state.

Accordingly, a user using the product storage 100 may efficiently manage the product storage 100 by checking whether a product is stored in the product storage 100 or checking an operating state of the product storage 100 through the LED module 142.

The product storage 100 including the above-described configuration may be implemented in a rectangular box structure, and a plurality of product storages may be stacked so that at least one of an upper end, a lower end, a left side surface, and a right side surface of one product storage is in contact with another product storage.

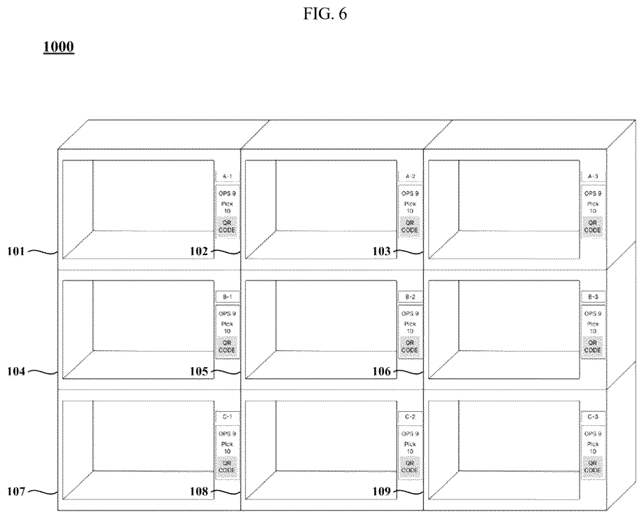

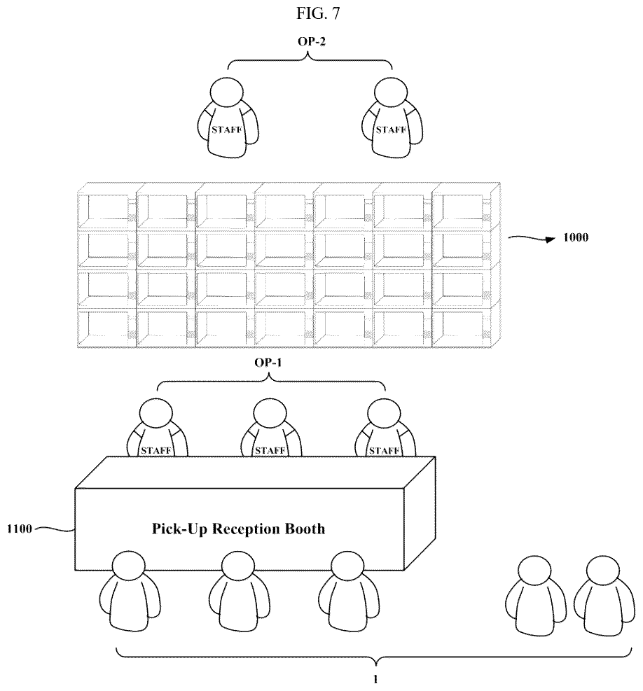

FIG. 6 is an example of a product storage module composed of a plurality of product storages according to an embodiment of the present disclosure, and FIG. 7 is an example of operators and purchasers using a pickup booth in which a product storage module is disposed according to an embodiment of the present disclosure.

Referring to FIGS. 6 and 7, a plurality of product storages 100 may be stacked to constitute a product storage module 1000.

In an embodiment, the product storage module 1000 may include at least one product storage 101, 102, 103, 104, 105, 106, 107, 108, and 109.

For example, the product storage module 1000 may include at least one product storage stacked according to a stacking scheme such as a 3×3, 4×4, or 5×5 configuration. In addition, the location information (i.e., a location number) assigned to each product storage 100 may vary depending on the stacking scheme.

In an embodiment, such a product storage module 1000 may be used and/or managed by a plurality of operators at an offline site.

In this regard, in an embodiment, the operators may be classified into a picking operator OP-1 who performs a picking operation at a front side of the product storage module 1000 and/or an inventory management operator OP-2 who performs an inventory management operation at a rear side of the product storage module 1000.

In an embodiment, an operator may be either the picking operator OP-1 and/or the inventory management operator OP-2 or an operator who performs both operations, but because the present disclosure is an invention for the pickup service including the picking process, the following description will be made based on that the operator is the picking operator for convenience of description.

In an embodiment, the picking operator OP-1 may face a plurality of purchasers 1 at a reception booth 1100.

In addition, in an embodiment, the picking operator OP-1 may pick predetermined products from the product storage module 1000 in sequence according to the products ordered by the purchaser 1.

In addition, in an embodiment, the picking operator OP-1 may provide the picked products to the purchaser 1 at the reception booth 1100.

In an embodiment, the inventory management operator OP-2 may replenish products in the product storage 100 or manage the product storage 100 in an error state at the rear side of the product storage module 1000.

In an embodiment, such an operator may perform the picking process based on the terminal 200 (specifically, an operator terminal) to pick the products ordered by the purchaser 1 from the product storage 100 and provide the picked products to the purchaser 1.

### Terminal 200

The terminal 200, according to an embodiment of the present disclosure, may be a predetermined computing device in which a pickup application (hereinafter, referred to as an application) providing the pickup service is installed.

In this regard, the application, according to an embodiment, may be classified into an application for an operator and an application for a purchaser.

In detail, in an embodiment, the application for an operator may be an application that provides the picking process for picking at least one product included in a purchaser's order from the plurality of product storages. In addition, in an embodiment, the application for a purchaser may be an application that orders at least one product and applies the pickup service to pick up the ordered products on site.

In this regard, the applications for an operator and a purchaser may be implemented as a single application that performs different functional operations depending on the user type.

That is, the applications for an operator and a purchaser may be implemented as a single application, but may be distinguished by granting different authorities and performing different functional operations according to operator and purchaser accounts.

In addition, the applications for an operator and a purchaser may be a pickup platform that provides an Internet environment so that a plurality of operators and purchasers may use the pickup service.

Referring back to FIG. 1, in an embodiment, the terminal 200 in which the pickup application as described above is installed may include an operator terminal 201 used by an operator and a purchaser terminal 202 used by a purchaser.

In an embodiment, a pickup application for seller may be installed in the operator terminal 201, and the pickup application for a purchaser may be installed in the purchaser terminal 202.

In this regard, the operator terminal 201 and the purchaser terminal 202 are for distinguishing the user types in an embodiment, and their components and functional operations may be the same.

Hereinafter, the operator terminal 201 and the purchaser terminal 202 will be described as mobile computing devices.

Specifically, from a hardware point of view, the terminal 200 may include a mobile computing device 200-1 and/or a desktop computing device 200-2 in which an application is installed.

In this regard, the mobile computing device 200-1 may be a mobile device such as a smart phone or a tablet PC in which an application is installed.

For example, the mobile computing device 200-1 may include a smart phone, a mobile phone, a digital broadcasting device, a personal digital assistant (PDA), a portable multimedia player (PMP), a tablet PC, and the like.

In addition, the desktop computing device 200-2 may include a fixed desktop PC and a personal computer, such as a laptop computer and an Ultrabook, in which a program for executing the pickup service based on wired/wireless communication is installed.

In addition, according to an embodiment, the terminal 200 may further include a predetermined server computing device that provides a pickup service environment.

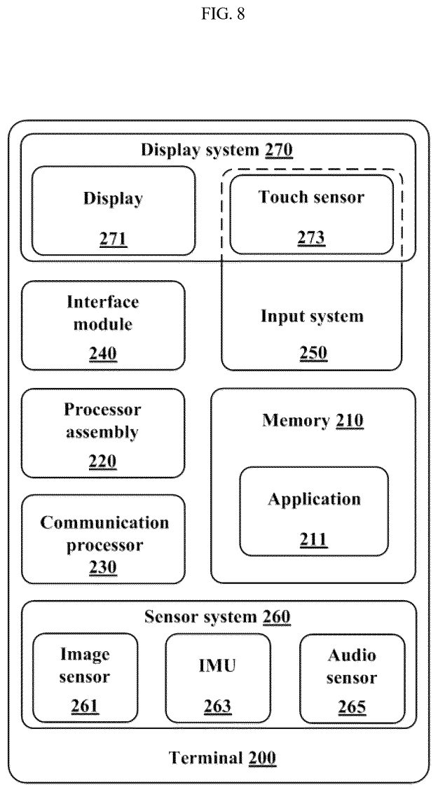

FIG. 8 is an internal block diagram of a terminal according to an embodiment of the present disclosure.

Referring to FIG. 8, from a functional point of view, the terminal 200 may include a memory 210, a processor assembly 220, a communication processor 230, an interface module 240, an input system 250, a sensor system 260, and a display system 270. These components may be included in the housing of the terminal 200.

Specifically, the memory 210 may store an application 211, and the application 211 may store one or more of various application programs, data, and instructions for providing the pickup service environment.

That is, the memory 210 may store commands and data that may be used to generate the pickup service environment.

In addition, the memory 210 may include a program area and a data area.

In this regard, the program area, according to an embodiment, may be linked between an operating system (OS) for booting the terminal 200 and functional elements, and the data area may store data generated according to the use of the terminal 200.

In addition, the memory 210 may include at least one non-transitory computer-readable storage medium and a transitory computer-readable storage medium.

For example, the memory 210 may be various storage devices such as a ROM, an EPROM, a flash drive, and a hard drive, and may include web storage that performs a storage function of the memory 210 on the Internet.

The processor assembly 220 may include at least one processor capable of executing instructions of the application 211 stored in the memory 210 to perform various tasks for generating the pickup service environment.

In an embodiment, the processor assembly 220 may control overall operations of the components through the application 211 of the memory 210 to provide the pickup service.

Such a processor assembly 220 may be a system-on-chip (SOC) suitable for the terminal 200 including a central processing unit (CPU) and/or a graphic processing unit (GPU), may execute an operating system (OS) and/or an application program stored in the memory 210, and may control the respective components mounted in the terminal 200.

In addition, the processor assembly 220 may be in communication with each component internally by a system bus, and may include one or more predetermined bus structures including a local bus.

In addition, the processor assembly 220 may be implemented to include at least one of an application specific integrated circuit (ASIC), a digital signal processor (DSP), a digital signal processing device (DSPD), a programmable logic device (PLD), a field programmable gate array (FPGA), a controller, a micro-controller, a microprocessor, and electrical units for performing other functions.

The communication processor 230 may include one or more devices for being in communication with an external device. Such a communication processor 230 may perform communication over a wireless network.

Specifically, the communication processor 230 may be in communication with the terminal 200 storing a content source for implementing the pickup service environment, and may be in communication with various user input components, such as a controller that receives a user input.

In an embodiment, the communication processor 230 may transmit and receive various data related to the pickup service to and from another terminal 200 and/or the external server.

Such a communication processor 230 may wirelessly transmit and receive data to and from at least one of a base station, an external terminal, and an arbitrary server over a mobile communication network built through a communication device capable of supporting technical standards for mobile communication or communication schemes (e.g., long term evolution (LTE), long term evolution-advanced (LTE-A), 5G new radio (5G NR), and WIFI), or short-range communication schemes.

The interface module 240 may connect the terminal 200 so as to be communicable with one or more other devices. Specifically, the interface module 240 may include a wired and/or wireless communication device compatible with one or more different communication protocols.

The terminal 200 may be connected to various input/output devices through the interface module 240.

For example, the interface module 240 may be connected to an audio output device such as a headset port or a speaker to output audio.

Although it has been described that the audio output device is connected through the interface module 240, an embodiment in which the audio output device is installed inside the terminal 200 may also be included.

In addition, for example, the interface module 240 may be connected to an input device such as a keyboard and/or a mouse to obtain a user input.

Such an interface module 240 may include at least one of a wired/wireless headset port, an external charger port, a wired/wireless data port, a memory card port, a port for connecting a device having an identification module, an audio input/output (I/O) port, a video input/output (I/O) port, an earphone port, a power amplifier, an RF circuit, a transceiver, and other communication circuits.

The input system 250 may sense a user input (e.g., a gesture, a voice command, a manipulation of a button, or another type of input) associated with the pickup service.

In detail, the input system 250 may include a predetermined button, a touch sensor, and/or an image sensor 261 that receives a user's motion input.

In addition, the input system 250 may be connected to an external controller through the interface module 240 to receive a user input.

The sensor system 260 may include various sensors such as the image sensor 261, a location sensor (IMU) 263, an audio sensor 265, a distance sensor, a proximity sensor, and a contact sensor.

In this regard, the image sensor 261 may capture an image and/or a video of a physical space around the terminal 200.

In an embodiment, the image sensor 261 may capture and obtain various images and/or videos related to the pickup service.

In addition, the image sensor 261 may be disposed on a front surface and/or a rear surface of the terminal 200 to capture an image in a direction in which it is disposed, and may capture the physical space through a camera oriented toward the outside of the terminal 200.

Such an image sensor 261 may include an image sensor device and an image processing module. In detail, the image sensor 261 may process a still image or a moving image obtained by the image sensor device (e.g., a CMOS or a CCD).

In addition, the image sensor 261 may process the still image or the moving image obtained through the image sensor device using an image recognition process (e.g., an OCR, etc.) and/or the image processing module to extract necessary information, and may transmit the extracted information to the processor.

Such an image sensor 261 may be a camera assembly including at least one camera. The camera assembly may include a general camera for capturing an image in a visible light band, and may further include a special-purpose camera such as an infrared camera, a stereo camera, or the like.

In addition, the image sensor 261 as described above may operate while being included in the terminal 200 according to an embodiment, or may operate in association with the above-described communication processor 230 and/or interface module 240 while being included in an external device (e.g., an external server, etc.).

The location sensor (IMU) 263 may sense at least one of a motion and an acceleration of the terminal 200. For example, it may be composed of a combination of various location sensors such as an accelerometer, a gyroscope, and a magnetometer.

In addition, the location sensor (IMU) 263 may recognize spatial information on the physical space around the terminal 200 by operating in association with the location communication processor 230 such as a GPS of the communication processor 230.

The audio sensor 265 may recognize a sound around the terminal 200.

Specifically, the audio sensor 265 may include a microphone capable of sensing a voice input of a user using the terminal 200.

In an embodiment, the audio sensor 265 may receive voice data necessary for the pickup service from a user.

The display system 270 may output various information related to the pickup service as a graphic image.

In an embodiment, the display system 270 may display various user interfaces for the pickup service (in an embodiment, a user interface for a purchaser and/or a user interface for an operator).

Such a display may include at least one of a liquid crystal display (LCD), a thin film transistor-liquid crystal display (TFT LCD), an organic light-emitting diode (OLED), a flexible display, a three-dimensional display (3D display), an e-ink display, and an electronic shelf label (ESL).

The components may be disposed in the housing of such a terminal 200, and the user interface may include a touch sensor 273 on the display 271 configured to receive a user's touch input.

In detail, the display system 270 may include the display 271 that outputs an image and the touch sensor 273 that senses a user's touch input.

Illustratively, the display 271 may be implemented as a touch screen by forming a layered structure with the touch sensor 273 or being integrally formed with the touch sensor 273. Such a touch screen may function as an input unit that provides an input interface between the terminal 200 and a user, and at the same time, may provide an output interface between the terminal 200 and a user.

The terminal 200 including the above-described components may store at least one set of purchase data, an order identification code, a receipt confirmation, a picking list, an electronic signature, receipt status information, pickup detail information, count information, picking information, location information, and/or display information in the memory 210 according to an embodiment.

In an embodiment, the purchaser terminal 202 may order at least one product and generate an order identification code according to the order.

In addition, in an embodiment, the operator terminal 201 may scan and obtain at least one order identification code.

In addition, in an embodiment, the operator terminal 201 may generate a picking list in which a picking sequence is determined in order to pick the at least one product included in the obtained order identification code.

In addition, in an embodiment, when picking the products included in the picking list from the product storage 100, the operator terminal 201 may scan a product identification code displayed on the display 140 of the corresponding product storage 100.

In addition, in an embodiment, the operator terminal 201 may obtain a purchaser's electronic signature according to the purchaser's input while delivering at least one picked product to the purchaser.

In addition, in an embodiment, the operator terminal 201 may generate a receipt and/or a receipt confirmation including the obtained purchaser's electronic signature.

In addition, in an embodiment, the operator terminal 201 may transmit the generated receipt and/or receipt confirmation to at least one purchaser terminal 202.

Accordingly, in an embodiment, the purchaser terminal 202 may obtain and view the receipt and/or the receipt confirmation including the purchaser's own electronic signature for the order for which pickup has been completed.

In one example, according to an embodiment, the terminal 200 may further perform at least some of functional operations performed by the central server 300 to be described later.

### Central Server 300

The central server 300, according to an embodiment of the present disclosure, may perform a series of processes for providing the pickup service.

In detail, the central server 300, according to an embodiment of the present disclosure, may perform the picking process in the operator terminal 201 and may perform the pickup process in the purchaser terminal 202 in order to provide the pickup service.

In detail, in an embodiment, the central server 300 may provide the pickup service by exchanging data necessary for operating the pickup process in an external device such as the terminal 200 with the external device.

In more detail, in an embodiment, the central server 300 may provide an environment in which the application 211 may operate in the external device (in an embodiment, the mobile computing device 200-1 and/or the desktop computing device 200-2).

To this end, the central server 300 may include an application program (in an embodiment, a pickup service providing program), data, and/or instructions for operating the application 211, and may transmit and receive various data based thereon to and from the external device.

In addition, in an embodiment, the central server 300 may perform various deep learning tasks for the pickup service in conjunction with a deep learning neural network.

In this regard, the deep learning neural network, according to an embodiment may include a convolution neural network (CNN), a Regions with CNN features (R-CNN), a Fast R-CNN, a Faster R-CNN, a Mask R-CNN, and the like, and may include any deep learning neural network including an algorithm capable of performing the embodiments to be described below. In an embodiment of the present disclosure, such a deep learning neural network itself is not limited or restricted.

In this regard, according to an embodiment, the deep learning neural network may be directly installed in the central server 300 or may operate as a separate device from the central server 300 to perform deep learning for the pickup service.

In the following embodiment, a description will be made based on an embodiment in which the deep learning neural network is directly installed in the central server 300 and performs deep learning.

In addition, in an embodiment, the central server 300 may read a predetermined deep learning neural network operating program built to perform the deep learning from a memory, and may perform deep learning as described below according to the read predetermined deep learning neural network system.

In an embodiment, the central server 300 may analyze insertion and removal of the product of the corresponding product storage 100 based on the sensing data received from the camera 110 and the weight sensor 120 of the product storage 100.

In addition, in an embodiment, the central server 300 may match location information to a unique identification number for each product storage 100.

In addition, in an embodiment, the central server 300 may match a product type to the unique identification number for each product storage 100 according to the product stored in the product storage 100.

In addition, in an embodiment, the central server 300 may transmit content to be displayed on the display 140 of each product storage 100 to the corresponding product storage 100.

In addition, in an embodiment, the central server 300 may extract at least one product included in the order identification code.

In addition, in an embodiment, the central server 300 may extract location information of a product storage pre-matched to the extracted product.

In addition, in an embodiment, the central server 300 may calculate an optimal picking route for picking the ordered products in the most efficient way based on the extracted location information.

In addition, in an embodiment, the central server 300 may generate a picking list by reflecting the calculated picking route.

In addition, in an embodiment, the central server 300 may update at least one picking list in real time according to picking process statuses of a plurality of operators.

In addition, in an embodiment, the central server 300 may obtain the first captured image captured by the camera 110 of the product storage 100.

In addition, in an embodiment, the central server 300 may recognize the product stored in the product storage 100 and/or a movement sensed in the product storage 100 based on the first captured image.

In addition, in an embodiment, the central server 300 may obtain a first weight sensed by the weight sensor 120 of the product storage 100.

In addition, in an embodiment, the central server 300 may determine whether the product is present in the product storage 100 based on the first weight.

In detail, in an embodiment, the central server 300 may determine that the product is not present in the product storage 100 when a weight obtained from the weight sensor 120 is zero.

On the other hand, in an embodiment, the central server 300 may determine that the product is present in the product storage 100 when a weight value exceeding zero is obtained from the weight sensor 120.

In addition, in an embodiment, the central server 300 may secondarily determine whether the product is present in the product storage 100 based on the first captured image.

In an embodiment, when a weight obtained from the weight sensor 120 is zero but the camera 110 senses a predetermined movement (e.g., a hand movement) and/or a shape (e.g., a shape of a stored product), the central server 300 may determine that the product storage 100 is in the error state.

In addition, in an embodiment, when a weight value exceeding zero is obtained from the weight sensor 120 but the camera 110 does not sense a predetermined movement (e.g., a hand movement) and/or a shape (e.g., a shape of a stored product), the central server 300 may determine that the product storage 100 is in the error state.

In addition, in an embodiment, the central server 300 may determine the availability information as one of the available state and/or the unavailable state based on the determined presence or absence of the product.

In detail, in an embodiment, when it is determined that the product is present in the product storage 100 (i.e., the product storage 100 is being used) or it is determined that the product storage 100 is in the error state, the central server 300 may determine the availability information as the unavailable state. The error state may include, for example, a case in which a weight variation fluctuates by a preset value or greater or a measured weight value is 0.

Accordingly, in an embodiment, the central server 300 may control the LED module 142 of the first product storage to emit red light.

In addition, in an embodiment, when an issue affecting the unavailable state is resolved, the central server 300 may reset the LED module 142 so as not to emit light, or may control the LED module 142 to emit blue light by changing the availability information to the available state.

In addition, in an embodiment, when it is determined that the product is not present in the product storage 100, the central server 300 may determine the availability information as the available state.

Accordingly, in an embodiment, the central server 300 may control the LED module 142 of the first product storage to emit blue light.

In addition, in an embodiment, the central server 300 may store and manage various application programs, instructions, and/or data used to implement the pickup service.

In an embodiment, the central server 300 may store and manage the purchase data, the order identification code, the receipt confirmation, the picking list, the electronic signature, the receipt status information, the pickup detail information, the count information, the picking information, the location information, the display information, the user interface for a purchaser, and/or the user interface for an operator.

However, in an embodiment of the present disclosure, the functional operations that may be performed by the central server 300 are not limited to the above-described operations, and additional functional operations may be performed.

Further referring to FIG. 1, in an embodiment, the central server 300 as described above may be implemented as a predetermined computing device including at least one processor module 310 for data processing, at least one communication module 320 for data exchange with an external device, and at least one memory module 330 for storing various application programs, data, and/or instructions for providing the pickup service.

In this regard, the memory module 330 may store one or more of an operating system (OS), various application programs, data, and instructions for providing the pickup service.

In addition, the memory module 330 may include a program area and a data area.

In this regard, the program area, according to an embodiment, may be linked between the operating system (OS) for booting a server and functional elements, and the data area may store data generated according to the use of the server.

In an embodiment, such a memory module 330 may be various storage devices such as a ROM, a RAM, an EPROM, a flash drive, a hard drive, and the like, or may be web storage that performs a storage function of the memory module 330 on the Internet.

In addition, the memory module 330 may be a recording medium in a form detachable from the server.

In one example, the processor module 310 may control the overall operations of the respective units described above in order to implement the pickup service.

Such a processor module 310 may be a system-on-chip (SOC) suitable for the server, including a central processing unit (CPU) and/or a graphics processing unit (GPU), may execute the operating system (OS) and/or the application program stored in the memory module 330, and may control the respective components mounted in the server.

In addition, the processor module 310 may be in communication with each component internally by a system bus, and may include one or more predetermined bus structures including a local bus.

In addition, the processor module 310 may be implemented to include at least one of an application specific integrated circuit (ASIC), a digital signal processor (DSP), a digital signal processing device (DSPD), a programmable logic device (PLD), a field programmable gate array (FPGA), a controller, a micro-controller, a microprocessor, and electrical units for performing other functions.

Although it has been described above that the central server 300 according to an embodiment of the present disclosure performs the functional operations as described above, according to an embodiment, at least some of the functional operations performed by the central server 300 may be performed by an external device (e.g., the terminal 200, etc.), at least some of the functional operations performed by the external device may be further performed by the central server 300, and various other embodiments may be possible.

### Method for Performing the Pickup Process by the Purchaser Terminal 202

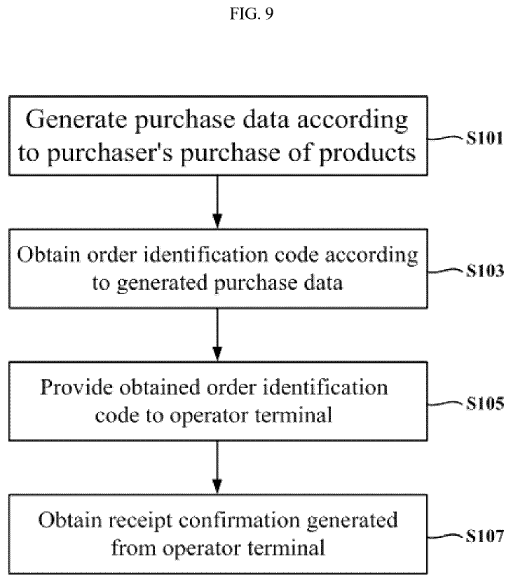

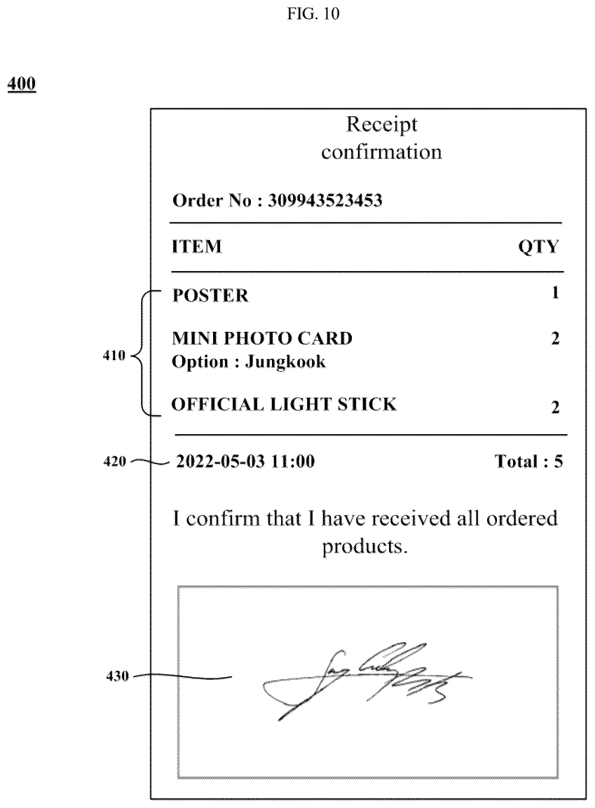

Hereinafter, a method in which the application 211 executed by at least one processor of the purchaser terminal 202 performs the pickup process to provide the pickup service according to an embodiment of the present disclosure will be described in detail with reference to FIGS. 9 and 10.

In an embodiment of the present disclosure, at least one processor of the purchaser terminal 202 may execute at least one application 211 stored in at least one memory 210 or allow the same to operate in a background state.

Hereinafter, the above-described method in which the at least one processor operates to execute instructions of the application 211 to perform the pickup process will be abbreviated as being performed by the purchaser terminal 202.

FIG. 9 is a flowchart for illustrating a method for performing a pickup process according to an embodiment of the present disclosure.

Referring to FIG. 9, in an embodiment, the purchaser terminal 202 may generate purchase data according to a purchaser's purchase of products (S101).

In detail, in an embodiment, the purchaser terminal 202 may generate purchase data when a purchaser selects at least one product and completes payment for the selected product(s).

In this regard, the purchase data according to an embodiment may be data including types, quantities, and/or an order serial number of the products purchased by the purchaser.

In addition, in an embodiment, the purchaser terminal 202 may provide a payment process for the selected at least one product in cooperation with an external terminal and/or a server.

In addition, in an embodiment, the purchaser terminal 202 may generate the purchase data for the at least one product for which payment has been completed according to the payment process.

In this regard, in an embodiment, the purchaser terminal 202 may sort the products included in the generated purchase data according to a predetermined condition and provide the sorted products as a pickup list.

The products included in the purchase data may be purchased in an online environment and picked up by the purchaser who directly visits an offline site.

In addition, in an embodiment, the purchaser terminal 202 may obtain an order identification code according to the generated purchase data (S103).

In this regard, the order identification code according to an embodiment may be a predetermined recognition medium containing the purchase data. In an embodiment, such an order identification code may be a QR code to which a unique identifier is pre-matched, and may be recognized based on a predetermined terminal.

In an embodiment, such an order identification code may be generated by the central server 300 by pre-matching the generated purchase data to the unique identifier of the recognition medium.

In addition, in an embodiment, the central server 300 may provide the generated order identification code to the purchaser terminal 202.

Accordingly, in an embodiment, the purchaser terminal 202 may obtain the order identification code.

In addition, in an embodiment, the central server 300 may additionally provide the receipt status information to the operator terminal 201 when the operator terminal 201 scans the corresponding order identification code depending on whether the pickup of the purchaser has been completed. This will be described in detail later in the section describing the picking process of the operator terminal 201.

That is, the order identification code according to an embodiment may include at least one of the types, the quantities, and/or the receipt status information of the products purchased by the purchaser.

In addition, in an embodiment, the purchaser terminal 202 may provide pickup detail information so that the products are picked up using the order identification code.

In this regard, in an embodiment, the pickup detail information may mean all information required for the purchaser to pick up the products. For example, the pickup detail information may include a pickup place, a pickup time, items required for pickup, and the like, and may be displayed as text, an image, and/or a video.

Referring back to FIG. 7, the purchaser 1 who has reviewed the pickup detail information may present the purchaser terminal 202, on which the obtained order identification code is displayed, to an operator at the reception booth 1100 at the offline site.

Accordingly, in an embodiment, the purchaser terminal 202 may provide the obtained order identification code to the operator terminal 201 (S105).

In this regard, in an embodiment, the operator terminal 201 may scan the presented order identification code and extract the unique identifier pre-matched to the scanned order identification code.

In addition, in an embodiment, the operator terminal 201 may detect the purchase data matched to the extracted unique identifier.

Accordingly, an operator using the operator terminal 201 may pick the at least one product included in the purchase data and provide the picked products to the purchaser.

In addition, in an embodiment, when the products are provided from the operator, the purchaser may input an electronic signature to the operator terminal 201 used by the operator who provided the pickup products.

Accordingly, the operator terminal 201 may generate a receipt and/or a receipt confirmation including the input electronic signature. In the following embodiment, the receipt confirmation may be referred to as a concept including a receipt.

In addition, in an embodiment, the purchaser terminal 202 may obtain the receipt confirmation generated from the operator terminal 201 (S107).

In this regard, receipt confirmation, according to an embodiment, may be data that proves the purchaser has received products matching the types and quantities purchased.

FIG. 10 is an example of a receipt confirmation according to an embodiment of the present disclosure.

Referring to FIG. 10, in an embodiment, the purchaser terminal 202 may obtain a receipt confirmation 400.

In an embodiment, the receipt confirmation 400 may include purchase data 410 (in detail, types, quantities, and/or an order serial number of the products), receipt date and time 420, and/or an electronic signature 430.

In an embodiment, such a receipt confirmation may be viewed by the purchaser terminal 202. In addition, when the operator terminal 201 according to an embodiment scans the order identification code and the receipt status information indicates a receipt-completed status, the receipt confirmation may be transmitted to the operator terminal 201 and viewed on the operator terminal 201.

### Method for Performing a Picking Process by Operator Terminal 201

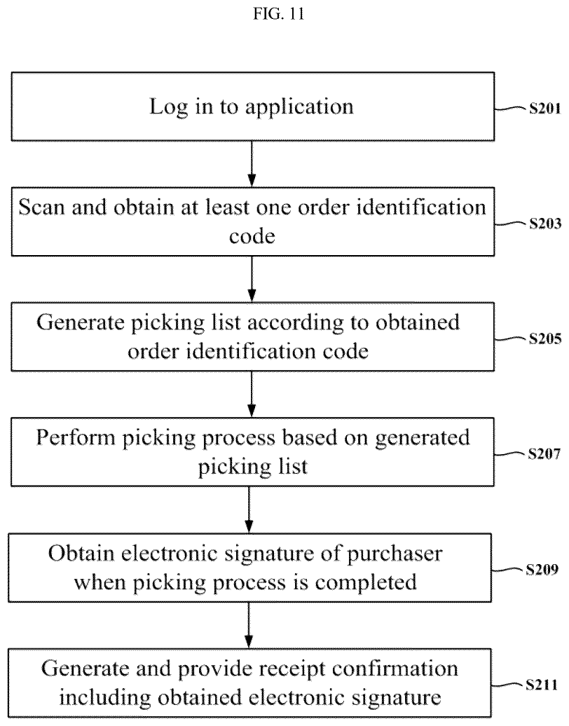

Hereinafter, a method in which the application 211 executed by at least one processor of the operator terminal 201 performs the picking process to provide the pickup service according to an embodiment of the present disclosure will be described in detail with reference to FIGS. 11 to 15.

In an embodiment of the present disclosure, at least one processor of the operator terminal 201 may execute at least one application 211 stored in at least one memory 210 or allow the same to operate in a background state.

Hereinafter, the above-described method in which the at least one processor operates to execute instructions of the application 211 to perform the pickup process will be abbreviated as being performed by the operator terminal 201.

FIG. 11 is a flowchart for illustrating a method for performing a picking process according to an embodiment of the present disclosure.

Referring to FIG. 11, in an embodiment, the operator terminal 201 may log in to an application for an operator (S201).

To this end, in an embodiment, the operator terminal 201 may provide a user interface for an operator for inputting an operator ID and/or an operation mode.

Accordingly, in an embodiment, an operator may input the operator ID and/or the operation mode.

The operator ID may be an ID randomly determined and assigned to a first operator among IDs previously generated and stored in the central server 300 according to the embodiment.

Further, the operation mode may include at least one of an application mode, a printer mode, and/or a reserve mode.

The application mode may refer to a mode in which a picking list is exposed in a digital form within an application. In addition, the printer mode may refer to a mode in which a picking list is output in a physical form (e.g., a paper receipt). In addition, the reserve mode may be a mode that is the same as the application mode, but has an additional function of reserving an output time point of a picking list.

In addition, in an embodiment, when the login is completed, the operator terminal 201 may scan and obtain at least one order identification code (S203).

The order identification code may be a predetermined recognition medium generated by the purchaser terminal 202 and/or the central server 300 when a purchaser selects at least one product and performs payment for the selected products on the purchaser terminal 202.

Purchase data, including types, quantities, and/or an order serial number of the products purchased by the purchaser, may be pre-matched to such an order identification code.

In an embodiment, when the login is completed, the operator terminal 201 may automatically execute the image sensor 261 capable of scanning the order identification code.

In addition, in an embodiment, the operator terminal 201 may scan the order identification code displayed on the purchaser terminal 202 based on the image sensor 261.

In this regard, in an embodiment, an operator may scan a plurality of order identification codes displayed on a plurality of purchaser terminals 202 at once.

In addition, in an embodiment, when the order identification code is normally recognized, the operator terminal 201 may automatically extract the order serial number included in the order identification code.

In this regard, when the order identification code is not recognized due to a temporary error or the like, in an embodiment, the operator terminal 201 may manually input the order serial number.

In addition, in an embodiment, the operator terminal 201 may obtain purchase data, receipt status information, and/or receipt confirmation matching the order serial number from the central server 300.

In this regard, the receipt status information according to an embodiment may be information indicating whether the purchaser has completed pickup or has not completed pickup with respect to the purchase data matched to the order serial number.

In an embodiment, when the purchaser has completed pickup, the central server 300 may set the receipt status information to the receipt-completed status. On the other hand, in an embodiment, when the purchaser has not completed pickup, the central server 300 may set the receipt status information to an unreceived status.

In this regard, when the receipt status information is the receipt-completed status, the operator terminal 201, according to an embodiment, may obtain the receipt confirmation from the central server 300.

In addition, in an embodiment, the operator terminal 201 may display at least one of the receipt status information and/or the receipt confirmation obtained from the central server 300.

For example, when the receipt status information of a first order serial number is the unreceived status, the text “PICKUP_NOT_COMPLETED” may be displayed. On the other hand, when the receipt status for the first order serial number is receipt-completed, receipt confirmation may be displayed with the text “PICKUP_COMPLETED”. In addition, when the first order serial number is an invalid serial number, the text “INVALID ORDER” may be displayed.

In this regard, the displayed receipt confirmation may include purchase data including types and quantities of products, receipt date and time, and/or an electronic signature, as illustrated in FIG. 10.

In one example, when the electronic signature is omitted in the receipt confirmation, in an embodiment, the operator terminal 201 may execute the user interface for the operator for inputting an electronic signature to obtain the electronic signature of the purchaser. In addition, in an embodiment, the operator terminal 201 may add and store the obtained electronic signature in the receipt confirmation.

That is, in an embodiment, the operator terminal 201 may activate picking list generation when the obtained order identification code corresponds to the unreceived status. On the other hand, when the obtained order identification code corresponds to the receipt-completed status, a receipt confirmation pre-matched to the corresponding order identification code may be output.

In addition, in an embodiment, the operator terminal 201 may generate a picking list according to the obtained order identification code (S205).

In detail, in an embodiment, the operator terminal 201 may generate the picking list in which a picking sequence is determined in order to pick at least one product included in the obtained order identification code.

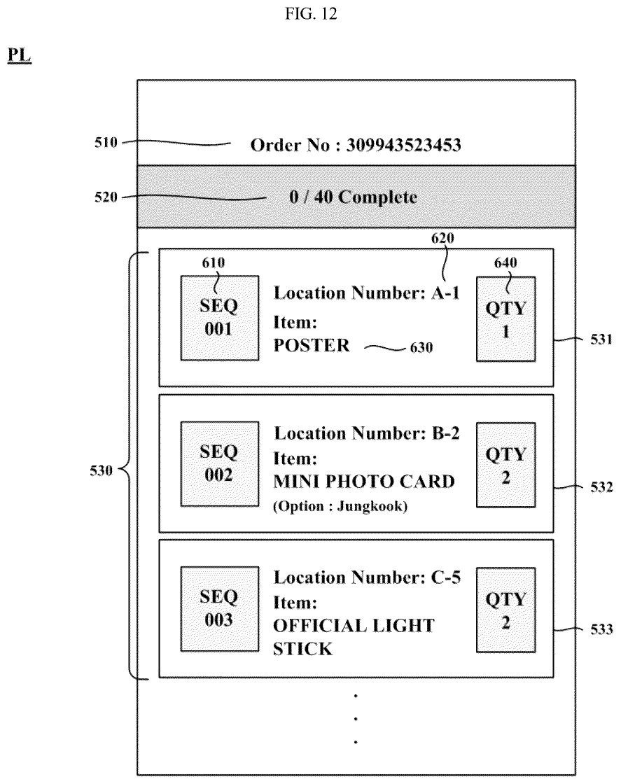

FIG. 12 is an example of a picking list according to an embodiment of the present disclosure.

Referring to FIG. 12, in an embodiment, the operator terminal 201 may display a picking list PL including an order serial number 510, count information 520, and/or a picking area 530.

The order serial number 510 may be an order serial number included in the obtained order identification code.

The count information 520 may be information indicating the number of times the operator should perform picking according to the types and/or quantities of the products purchased by the purchaser. For example, the count information 520 may be displayed as “the number of completed pickings/the total number of pickings”.

The picking area 530 may include at least one set of picking information 531, 532, and 533.

In this regard, the picking information 531, 532, and 533 may include a picking sequence 610, a picking location 620, a product to be picked 630, and/or a picking quantity 640.

The picking sequence 610 may indicate a sequence in which the operator should pick the products, and may be displayed as, for example, “SEQ 001”.

In addition, the picking sequence 610 may be sorted in ascending order, such that a smaller value corresponds to a product to be picked earlier.

In addition, in terms of the picking sequence 610, picking may be performed only in the sorted sequence, and the operator terminal 201 may prevent picking that is out of sequence.

The picking location 620 may be location information pre-matched to a unique identification number for each product storage 100.

The product to be picked 630 may be a product type pre-matched to the location information. For example, it may be displayed as “OO official cheering stick”.

The picking quantity 640 may be a quantity of products that the operator should pick, and may be displayed as, for example, “QTY 1”.

In this regard, in order to generate the picking list PL, in an embodiment, the operator terminal 201 may obtain location information and a product type pre-matched to each merchandise storage 100 from the central server 300.

Referring back to FIG. 6, for example, the central server 300 may allocate location information to the respective illustrated nine product storages 100 based on rows and columns thereof.

For example, first to third product storages 101, 102, and 103 may be sequentially allocated with location information of “A-1”, “A-2”, and “A-3”. In addition, fourth to sixth product storages 104, 105, and 106 may be allocated with location information of “B-1”, “B-2”, and “B-3”. In addition, the seventh to ninth product storages 107, 108, and 109 may be allocated with location information of “C-1”, “C-2”, and “C-3”.

In this regard, the location information and/or the product type pre-matched to each merchandise storage 100 may be displayed on the first label indicator 141-1 and/or the second label indicator 141-2 of the corresponding product storage 100. By contrast, the location information may be displayed in a text format, whereas the product type may be displayed on the first label indicator 141-1 and/or the second label indicator 141-2 as a product identification code (e.g., a QR code) including information on the corresponding product type.

Accordingly, in an embodiment, the operator terminal 201 may obtain the location information allocated to each merchandise storage 100 and the product type pre-matched to the corresponding product storage.

In addition, in order to determine the picking sequence 610 of at least one product included in the picking list PL, in an embodiment, the operator terminal 201 may extract at least one product type included in an obtained first order identification code.

In addition, in an embodiment, the operator terminal 201 may extract location information to which the extracted product type is pre-matched.

In addition, in an embodiment, the operator terminal 201 may automatically sort the extracted location information according to a preset condition.

In detail, in an embodiment, the operator terminal 201 may sort the extracted location information in one direction along columns of the product storages in an n-th row and in a reverse direction along columns of the product storages in an (n+1)-th row.

For example, when it is assumed that a purchaser has purchased all nine different products stored in the respective product storages of the product storage module 1000 illustrated in FIG. 6, the operator terminal 201 may automatically sort the location information in the sequence of “A-1”, “A-2”, “A-3”, “B-3”, “B-2”, “B-1”, “C-1”, “C-2”, and “C-3”.

That is, in an embodiment, the operator terminal 201 and/or the central server 300 may calculate an optimal picking route based on storage locations of respective products, thereby increasing promptness in service provision, enabling fast work processing, and thus increasing customer satisfaction.

In addition, in an embodiment, the operator terminal 201 may determine the picking sequence 610 for products included in the first order identification code in the automatically sorted sequence.

In addition, in an embodiment, the operator terminal 201 may display at least one product on the picking list PL according to the determined picking sequence 610.

In one example, the central server 300, according to an embodiment, may update the picking list PL in real time according to picking statuses of other operators.

In addition, in an embodiment, the operator terminal 201 may display the picking location 620, the product to be picked 630, and/or the picking quantity 640 for a first product, which corresponds to a product to be picked first according to the picking sequence.

In one example, in an embodiment, when the plurality of order identification codes displayed on the plurality of purchaser terminals 202 are scanned at once, the operator terminal 201 may generate a single picking list by summing quantities of each product type included in the plurality of order identification codes. In this regard, the picking list according to an embodiment may display picking quantities for each picking basket.

For example, when two units of the first product are included in an order identification code of a first purchaser and three units of the first product are included in an order identification code of a second purchaser, the operator terminal 201 may generate a picking list indicating that a total picking quantity is five, and further indicating that two units of the first product are to be placed into a picking basket of the first purchaser, and three units of the first product are to be placed into a picking basket of the second purchaser.

Accordingly, in an embodiment, the operator terminal 201 may perform the picking process based on the generated picking list PL (S207).

In detail, in an embodiment, the operator terminal 201 may perform the picking process of picking the first product, which corresponds to a product to be picked first according to the picking sequence, by a first quantity from the first product storage in which the first product is stored, based on the generated picking list PL.

To this end, based on the picking location 620 of the product to be picked first according to the picking sequence displayed on the generated picking list PL, the operator may access the first product storage at the corresponding location.

In addition, the operator may open the cover CV of the first product storage and take out the first product stored therein according to the picking quantity 640.

In addition, the operator may process the picking process for a product that has actually been picked based on the operator terminal 201.

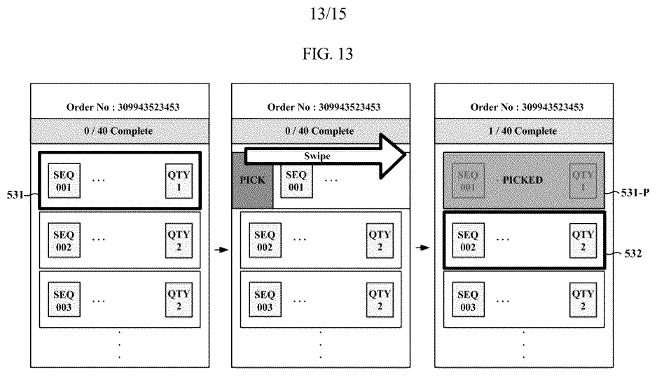

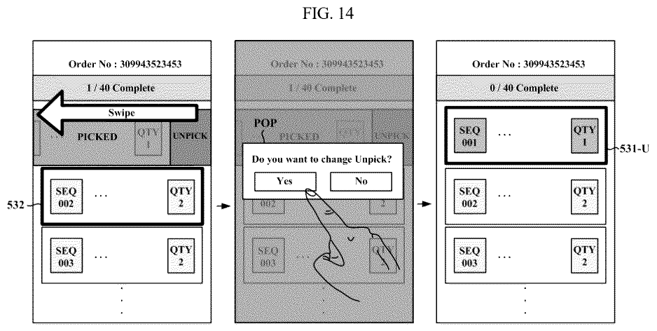

FIGS. 13 and 14 illustrate examples of an operator performing a picking process based on a picking list displayed on an operator terminal according to an embodiment of the present disclosure.

Referring to FIG. 13, in an embodiment, the operator terminal 201 may select a first picking area in which first picking information 531 is displayed in order to perform picking.

In addition, in an embodiment, the operator terminal 201 may slide and/or swipe the selected first picking area from left to right.

When the first picking area is slid and/or swiped, in an embodiment, the operator terminal 201 may operate the image sensor.

In an embodiment, the operator may scan a product identification code, which is an identification code for a product stored in the first product storage, with the image sensor in operation.

In this regard, the product identification code may be displayed on the first and/or second label indicators 141-1 and 141-2 of the first product storage.

In addition, in an embodiment, the operator terminal 201 may determine whether the picking is normal based on the product identification code obtained through the scanning.

In detail, in an embodiment, when the product to be picked 630 included in first picking information 531 is the same as a product type pre-matched to the scanned product identification code, the operator terminal 201 may determine the picking as a normal picking.

In addition, in an embodiment, the operator terminal 201 may verify whether the picking is normal while operating in association with the central server 300. Hereinafter, a process performed by the central server 300 may be described as being performed by the operator terminal 201.

To this end, in an embodiment, the central server 300 may sense the number of at least one product in the first product storage based on the first captured image and/or the first weight obtained from the first product storage.

In addition, in an embodiment, the central server 300 may calculate the quantity of picked products based on the sensed number of products.

In addition, in an embodiment, the central server 300 may transmit the calculated product quantity to the operator terminal 201.

That is, in an embodiment, the operator terminal 201 may operate in association with the central server 300 to obtain the weight of the products measured by the weight sensor 120 of the first product storage, thereby determining whether the picking is normal.

In detail, in an embodiment, the operator terminal 201 may calculate first quantity data based on the first weight at a first time point, which is a time point before the products are taken out (before picking) from the first product storage.

In addition, in an embodiment, the operator terminal 201 may calculate second quantity data based on a second weight at a second time point, which is a time point after the products are taken out (after picking).

In this regard, in an embodiment, the operator terminal 201 may verify whether the picking is normal by comparing the first and second quantity data to each other.

In detail, in an embodiment, when a value obtained by subtracting the number indicated by the second quantity data from the number indicated by the first quantity data matches the picking quantity 640, the operator terminal 201 may determine the corresponding picking as the normal picking.

In addition, in an embodiment, the operator terminal 201 may operate in association with the central server 300 to obtain an image captured by the camera 110 of the first product storage, thereby determining whether the picking is normal.

In detail, in an embodiment, the operator terminal 201 may calculate the first quantity data by sensing the number of products in the first captured image at the first time point in the first product storage.

In addition, in an embodiment, the operator terminal 201 may calculate the second quantity data by sensing the number of products in a second captured image at the second time point.

The following procedure is the same as the procedure for verifying whether the picking is normal based on the weight sensor, and thus a redundant description thereof will be omitted.

In addition, in an embodiment, the operator terminal 201 may determine that the picking is normal only when the first movement data sensed in the first product storage is obtained based on the camera 110 of the first product storage.

In addition, in an embodiment, the operator terminal 201 may activate picking information of a next product only when the picking information of the product having the highest priority in the picking sequence is determined as the normal picking.

Accordingly, in an embodiment of the present disclosure, because the normal picking of the products inserted into and removed from the product storage is determined through a triple procedure including the identification code (e.g., QR code) comparison, the comparison using the camera of the product storage, and the comparison using the weight sensor, the probability of occurrence of mis-picking is greatly reduced, thereby preventing time/economic losses due to mis-picking.

In addition, in an embodiment, when the first picking information 531 is determined to be the normal picking, the operator terminal 201 may display predetermined content indicating normal picking in an area including the first picking information 531. Hereinafter, the first picking information determined as normal picking and allowing the predetermined content to be displayed will be referred to as first completed picking information 531-P.

For example, as illustrated in FIG. 13, the color of the area including the first picking information 531 is changed to green, and the text “PICKED” may be displayed.

At the same time, in an embodiment, the operator terminal 201 may automatically focus a second picking area in which second picking information 532, which corresponds to a product to be picked next according to the picking sequence, is displayed.

For example, the operator terminal 201 may display predetermined content such that a border of an area including the second picking information 532 is emphasized.

Similar to the above-described procedure, in an embodiment, the operator may perform the picking process in the same manner to complete picking for all products included in the picking list PL.

In addition, in an embodiment, the operator terminal 201 may slide and/or swipe the first completed picking information 531-P from right to left to perform picking cancelation.

In this regard, in an embodiment, the operator terminal 201 may display a pop-up POP for determining whether to cancel picking. For example, when “Yes” is selected in the pop-up POP including a question “Do you want to cancel picking?”, the picking cancelation may be determined.

Accordingly, in an embodiment, the operator terminal 201 may change the status of the first completed picking information 531-P to first canceled picking information 531-U.

In addition, in an embodiment, the operator terminal 201 may automatically focus an area in which the first canceled picking information 531-U is displayed.

In this regard, in an embodiment, the operator is able to perform picking corresponding to the next picking information only when the picking for the canceled first completed picking information 531-P is re-performed.

In addition, in an embodiment, the operator terminal 201 may activate a picking completion button when the picking process of all products included in the picking list PL is performed.

In this regard, when an input to the picking completion button is sensed, in an embodiment, the operator terminal 201 may determine that the picking process has been completed.

In addition, in an embodiment, the operator terminal 201 may obtain an electronic signature of a purchaser when the picking process is completed (S209).

To this end, in an embodiment, after the picking process is completed, the operator terminal 201 may obtain the electronic signature of the purchaser confirming that the purchaser has normally picked up all purchased products based on the user interface for the operator.

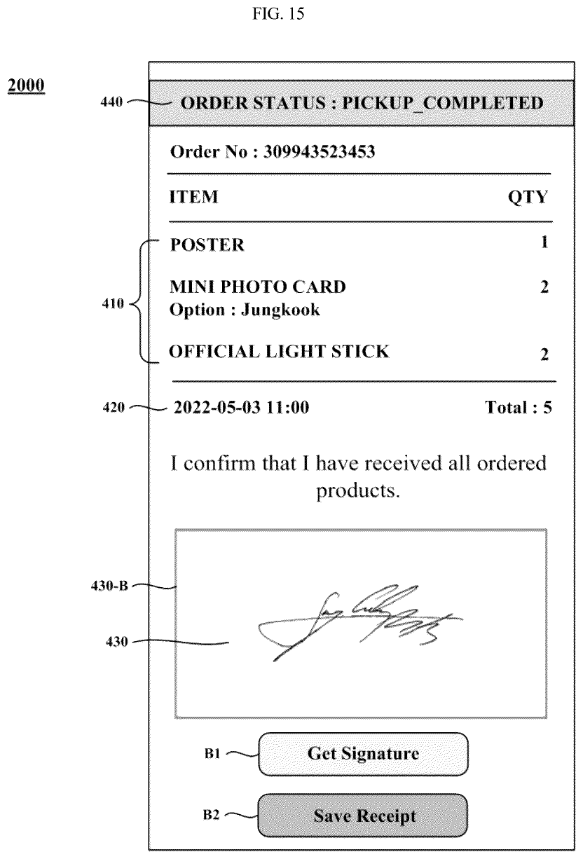

FIG. 15 is an example of a user interface for an operator for inputting an electronic signature according to an embodiment of the present disclosure.

Referring to FIG. 15, in an embodiment, the operator terminal 201 may display, on a user interface 2000 for an operator, the purchase data 410 (in detail, the types, quantities, and/or order serial number of the purchased products) matched to the purchaser, the receipt date and time 420, an electronic signature input box 430-B, and/or the receipt status information 440.

In addition, in an embodiment, the operator and the purchaser may compare the purchase data with the products actually received to determine whether the purchaser has normally picked up all purchased products.

In this regard, when it is determined that the pickup is normal, the operator, according to an embodiment, may activate the electronic signature input box 430-B by pressing a first button B1 on the user interface 2000 for the operator.

Accordingly, the purchaser, according to an embodiment, may input the electronic signature 430 into the activated electronic signature input box 430-B.

In addition, in an embodiment, when the electronic signature 430 is normally input, the operator terminal 201 may press a second button B2 to obtain and store the corresponding electronic signature 430.

In addition, in an embodiment, when the electronic signature 430 is normally input, the operator terminal 201 may change the receipt status information 440 from the unreceived status to the receipt-completed status and display the updated information on the user interface 2000 for the operator.

In addition, in an embodiment, the operator terminal 201 may generate and provide a receipt confirmation including the obtained electronic signature 430 (S211).

In this regard, the receipt confirmation 400 may be generated including the purchase data 410 (in detail, the types, quantities, and/or order serial number of the products), the receipt date and time 420, and/or the electronic signature 430 as illustrated in FIG. 10.

In an embodiment, the operator terminal 201 may transmit the receipt confirmation generated as such to the purchaser terminal 202 and/or the central server 300.

That is, the purchaser who has received the receipt confirmation may view and/or check the corresponding receipt confirmation when accessing the purchaser's own account.

Accordingly, in an embodiment of the present disclosure, the operator terminal 201 may generate data for certifying a normal pickup while including the electronic signature of the purchaser, thereby preventing duplication and omission in the pickup to prevent economic loss, securing objective data for proving mis-picking, and thus improving reliability between the customer and the service provider.

As described above, the product storage according to an embodiment of the present disclosure has a structure for managing storage statuses and insertion and removal of the pickup target products loaded therein, thereby enabling identification of a time point at which loading is required, and allowing personnel separate from personnel performing picking to perform loading to greatly increase the efficiency of picking work.

In addition, the product storage according to an embodiment of the present disclosure includes a device for assisting a normal picking of the operator, thereby greatly reducing the probability of occurrence of mis-picking to prevent time/economic losses due to mis-picking.

In addition, the method for providing the pickup service using the product storage according to an embodiment of the present disclosure generates an order form according to types and quantities of products ordered by a customer, thereby reducing face-to-face time between the customer and an operator to increase procedural convenience, and improving convenience for the operator in performing picking work based on the order form.

In addition, the method for providing the pickup service using the product storage according to an embodiment of the present disclosure calculates an optimal picking route based on storage locations of respective products, thereby increasing promptness in service provision, enabling fast work processing, and thus increasing customer satisfaction.

In addition, the method for providing the pickup service using the product storage, according to an embodiment of the present disclosure, updates a picking list based on the picking sequences of other operators, thereby preventing overlap of picking routes between operators, reducing confusion, and thereby reducing the total time required to perform picking work.

In addition, the method for providing the pickup service using the product storage according to an embodiment of the present disclosure generates data for certifying a normal pickup while including an electronic signature of a customer, thereby preventing duplication and omission in pickup of the customer to prevent economic loss, securing objective data for proving mis-picking, and thus improving reliability between the customer and a service provider.

The embodiments of the present disclosure described above may be implemented as program instructions that are executed by various computer components and recorded on a computer-readable medium. The computer-readable recording medium may include program instructions, data files, data structures, and the like alone or in combination. The program instructions recorded in the computer-readable recording medium may be specially designed and configured for the present disclosure or may be known and available to those skilled in the field of computer software. Examples of the computer-readable recording media include magnetic media such as hard disks, floppy disks, and magnetic tapes, optical recording media such as CD-ROMs and DVDs, magneto-optical media such as floptical disks, and hardware devices specially configured to store and execute program instructions such as ROM, RAM, flash memory, and the like. Examples of the program instructions include not only machine language codes such as those generated by a compiler, but also high-level language codes that may be executed by a computer using an interpreter or the like. The hardware devices may be changed to one or more software modules to perform processing according to the present disclosure, and vice versa.

The specific executions described in the present disclosure are merely embodiments, and do not limit the scope of the present disclosure in any manner. For the sake of brevity of the present document, descriptions of conventional electronic components, control systems, software, and other functional aspects of the systems may be omitted. In addition, the connections of lines or connection members between the components illustrated in the drawings exemplarily represent functional connections and/or physical or circuit connections, and may be represented as various functional connections, physical connections, or circuit connections that are replaceable or additional in an actual device. In addition, when there is no specific mention such as “essential”, “important”, or the like, a component may not be an essential component for the application of the present disclosure.

In addition, although the detailed description of the present disclosure has been described with reference to the preferred embodiments of the present disclosure, those skilled in the art or having ordinary knowledge in the technical field will understand that the present disclosure may be variously modified and changed within the scope not departing from the spirit and technical scope of the present disclosure as set forth in the claims to be described later. Therefore, the technical scope of the present disclosure should not be limited to the contents described in the detailed description of the present document, but should be defined by the claims.

### Mode for Invention

The mode for carrying out the invention is the same as the best mode for carrying out the invention described above.

### Industrial Applicability

The present disclosure is industrially applicable in that, in the entertainment market which is gradually increasing in scale with the expansion of K-POP, particularly at concert venues where large crowds gather at a specific time and thus the possibility of confusion is very high, on-site congestion may be alleviated by reducing an error rate and increasing promptness of a sales process ranging from inventory management to delivery to consumers for various merchandise.

1. A product storage for storing at least one product therein and managing insertion and removal of the stored product, the product storage comprising:
a main frame having an accommodation space defined therein;
a camera configured to capture the accommodation space defined within the main frame;
a weight sensor configured to measure a weight of at least one product stored in the accommodation space defined within the main frame; and
a communication module configured to transmit and receive, to and from a central server, (i) data received from the camera and (ii) data received from the weight sensor.

2. The product storage of claim 1, wherein the camera is disposed at a center of an inner surface of an upper end of the main frame.

3. The product storage of claim 1, wherein the weight sensor is spaced apart from a bottom surface of a lower end of the main frame by a predetermined clearance.

4. The product storage of claim 1, further comprising a central server in communication with the communication module and configured to transmit and receive the data received from the camera and the weight sensor,
wherein the central server is configured to control the product storage by analyzing insertion and removal of the at least one product in the product storage based on the data received from the camera and the weight sensor.

5. The product storage of claim 4, wherein when the product storage includes a plurality of product storages, the central server is configured to match location information to a unique identification number for each product storage.

6. The product storage of claim 1, wherein the main frame has a front surface and/or a rear surface thereof configured to open at one side so that the accommodation space within the main frame is in communication with the outside,
wherein the main frame further includes a cover disposed on at least one of the front surface and/or the rear surface and pivotable in a structure of opening and closing.

7. The product storage of claim 1, wherein the main frame further includes:
a first label indicator disposed on a front surface of the main frame; and
a second label indicator disposed on a rear surface of the main frame.

8. The product storage of claim 7, wherein the first label indicator is a display module configured to display first display information including at least one of location information, pickup worker information, a pickup quantity, and a product identification code.

9. The product storage of claim 7, wherein the second label indicator is a display module configured to display second display information including at least one of location information, availability information, and a product identification code.

10. The product storage of claim 9, wherein the second label indicator includes an LED module configured to emit light based on the availability information.

11. The product storage of claim 1, wherein the main frame is formed in a box shape such that, when the product storage includes a plurality of product storages arranged adjacent to each other, at least one of an upper end, a lower end, a left side surface, and a right side surface thereof is in contact with another product storage.

12. The product storage of claim 1, wherein the communication module is configured to transmit, to the central server, a first captured image received from the camera and obtained by capturing the at least one product stored within the main frame and insertion and removal of the at least one product.

13. The product storage of claim 1, wherein the communication module is configured to transmit, to the central server, a first weight received from the weight sensor and obtained based on the at least one product stored within the main frame.

14. The product storage of claim 4, wherein the central server is configured to:
determine, when the product storage includes a plurality of product storages, whether products are present within a first product storage based on at least one of a first captured image and a first weight obtained for the first product storage; and
determine availability information as either an available state or an unavailable state based on the determined presence or absence of the products.

15. The product storage of claim 14, further comprising an LED module configured to emit light based on the availability information, wherein the central server is configured to:
control the LED module to emit blue light when the availability information indicates an available state; and
control the LED module to emit red light when the availability information indicates an unavailable state.

16. The product storage of claim 14, wherein the central server is configured to calculate a quantity of products within the first product storage based on the first captured image and the first weight.
